(19) United States
(12) Patent Application Publication
(10) Pub. No.: US 2004/0176168 A1
(43) Pub. Date: Sep. 9, 2004

(54) Method and system of real-time video-audio interaction

(76) Inventors: Hsi-Kang Tsao, Taipei City (TW); Li-Hsiang Liao, Zhongli City (TW)

Correspondence Address: RABIN & Berdo, PC, 1101 14TH STREET, NW, SUITE 500, WASHINGTON, DC, 20005, US

(21) Appl. No.: 10/793,034

(22) Filed: Mar. 5, 2004

(30) Foreign Application Priority Data
Mar. 7, 2003 (TW) 92104993

(51) Int. Cl. A63F 13/00

(52) U.S. Cl. 463/42

(57) ABSTRACT

A method of real-time video-audio interaction in an Internet game. An Internet transmission channel is established between Internet game clients without connection to the Internet game server. First, the method retrieves real-time video and audio data and compresses it into video and audio data packets. Next, the video and audio data packets are packaged into a transmission package to transmit to other game clients through the Internet transmission channel. Finally, the Internet game client receives the transmission package decompresses the received transmission package into video and audio data, and executes output thereof.

### BACKGROUND OF THE INVENTION

1. Field of the Invention

The present invention relates to real-time video-audio interaction technology, and in particular to a method of real-time video-audio interaction in an Internet game.

2. Description of the Related Art

Generally speaking, the system architecture of an Internet game comprises an Internet game server and Internet game clients. The Internet game server receives and processes data from the Internet game clients to execute the Internet game. The Internet game clients interact with other Internet game clients and the Internet game. In other words, all the data required by the Internet game is sent to the Internet game server for data processing and data operation. Real-time video-audio interaction utilizes a camera and microphones in an Internet game client to retrieve the real-time data and transmit the retrieved data through the Internet to other Internet game clients for interaction.

Three main technological difficulties limit Internet game systems' support of real-time video-audio interaction. First, current video display technology in an Internet game cannot display a real-time video picture if 3D animation occupies the display. Second, if the compression and transmission of video and audio data are executed solely in the Internet game server, the server becomes overloaded and bandwidth is compromised, affecting the speed of the Internet game. Third, the degree of video and audio data synchronization affects the result in real-time interaction. Hence, presently, real-time video-audio interaction is not supported in an Internet game.

### SUMMARY OF THE INVENTION

Accordingly, an object of the invention is to provide a method of establishing an Internet transmission channel between Internet game clients, compressing and packaging real-time video-audio data in the Internet game clients, and transmitting the packaged data to other Internet game clients. The Internet game client that receives the transmission package, i.e. the recipient Internet game client, decodes the transmission package and applies a module simultaneously supporting real-time video and 3D animation to display the real-time video data when 3D animation occupies the display in an Internet game. In addition, the recipient Internet game client utilizes a sound card, cooperating with audio input or output, to output the real-time audio data back. The module simultaneously supporting real-time video and 3D animation outputs the real-time video data by integrating the real-time video data into game environments of the Internet game as texture mapping, accomplishing simultaneous display.

To achieve the foregoing and other objects, the invention overcomes conventional real-time data interaction problems in an Internet game. In one embodiment, the inventive method first establishes an Internet transmission channel between sender and recipient Internet game clients, without first connecting to an Internet game server. Next, the Internet game clients execute the Internet game and connect to the Internet game server.

Then, real-time video and audio data are retrieved in the sender Internet game client, which then compresses/encodes the retrieved real-time video data into video data frames, compresses/encodes the real-time audio data into audio data packets, packaging both into a transmission package. The transmission package is then transmitted to the recipient Internet game client through the Internet transmission channel. A time stamp is attached in the transmission package for synchronizing the video and audio data.

Finally, the recipient Internet game client decodes the transmission package into real-time video and audio data. The recipient Internet game client synchronizes the real-time video and audio data according to the time stamp, outputs the decoded real-time video data in game environments, and outputs the decoded real-time audio data, achieving real-time vide-audio interaction in the Internet game.

### BRIEF DESCRIPTION OF THE DRAWINGS

The present invention can be more fully understood by reading the subsequent detailed description and examples with references made to the accompanying drawings, wherein:

FIG. 1 is a flowchart of the method of real-time video-audio interaction in an Internet game.

FIG. 2 is a diagram of the system of real-time video-audio interaction in an Internet game.

FIG. 3 is a detailed diagram of the system of real-time video-audio interaction in an Internet game.

FIG. 4a, FIG. 4b are diagrams of the method of real-time video-audio interaction in an Internet game.

### DETAILED DESCRIPTION OF THE INVENTION

As summarized above, the present invention provides a system and method overcoming conventional real-time data interaction problems in an Internet game, first establishing an Internet transmission channel between Internet game clients without first connecting to an Internet game server. Next the Internet game clients execute the Internet game and connect to the Internet game server.

The Internet transmission channel is established as follows. First, the sender Internet game client designates an Internet address of a recipient Internet game client directly or according to a directory which may include all the Internet addresses of possible recipient Internet game clients. The sender Internet game client then transmits a connection request to the recipient Internet game client. The recipient Internet game client establishes the Internet transmission channel according to the connection request.

Real-time video and audio data are retrieved in the sender Internet game client, which then compresses/encodes the retrieved real-time video data into video data frames, the real-time audio data into audio data packets, packaging both into a transmission package. The transmission package is then transmitted to the recipient Internet game client through the Internet transmission channel.

If the bandwidth of the Internet transmission channel is not sufficient to transmit the real-time video and audio data, the real-time audio data takes a higher transmission priority than the real-time video data. Otherwise, a time stamp is attached in the transmission package for synchronizing the real-time audio data and real-time video data.

Finally, the recipient Internet game client decodes the transmission package into real-time video and audio data. The recipient Internet game client synchronizes the real-time video and audio data according to the time stamp, outputs the decoded real-time video data in game environments, and outputs the decoded real-time audio data.

Further, the invention provides a system of real-time video-audio interaction in an Internet game. The inventive system includes an Internet game server and Internet game clients. The Internet game server executes an Internet game main program. The Internet game clients comprise interactive Internet game clients and an Internet transmission channel. The Internet game clients connect to the Internet game server, and the Internet transmission channel connects to the interactive Internet game clients, i.e. the sender and recipient Internet game clients.

The sender Internet game client has a real-time data retriever, data encoder, transmission packager, and Internet sender. The real-time data retriever retrieves real-time video and audio data in the Internet game client. The data encoder compresses/encodes the real-time video data into video data frames, and the real-time audio data into audio data packets. The transmission packager then packages the encoded video and audio data packets into a transmission package. The Internet sender transmits the transmission package to the recipient Internet game client through the Internet transmission channel.

Here, the Internet transmission channel is established according to the steps mentioned. Again, if the bandwidth of the Internet transmission channel cannot accommodate the real-time audio and video data simultaneously, the real-time audio data always takes a higher transmission priority than the real-time video data. The transmission package also includes a time stamp synchronizing the real-time audio and video data.

The recipient Internet game client includes a data decoder and a video-audio playback system. The data decoder decodes the transmission package into real-time video and audio data. The video-audio playback system outputs the decoded video and audio data according the time stamp attached in the transmission package. Similarly, the video-audio playback system integrates the decoded real-time video data into game environments of the Internet game as texture mapping.

Moreover, the invention provides a method of real-time video-audio interaction in an Internet game for application to an Internet game client. First, the Internet game client establishes an Internet transmission channel to an external Internet game client without first connecting to the Internet game server. The Internet game client then connects to the Internet game server and executes the Internet game.

Next, real-time video and audio data are retrieved by a real-time data retriever and compressed/encoded into a transmission package. The transmission package is transmitted to the external Internet game client through the Internet transmission channel.

Here, the Internet transmission channel is established by certain steps. The Internet game client designates an Internet address of the external Internet game client directly or according to a directory which may include all the Internet addresses of possible external Internet game clients. The Internet game client then transmits a connection request to the external Internet game client. The external Internet game client establishes the Internet transmission channel according to the connection request. If the bandwidth of the Internet transmission channel cannot support the real-time audio data and video data simultaneously, the real-time audio data takes a higher transmission priority than the real-time video data. The transmission package also includes a time stamp synchronizing the real-time audio data and real-time video data.

The Internet game client receives a transmission package from the external Internet game client through the Internet transmission channel. The Internet game client decompresses/decodes the transmission package into real-time video and audio data. The Internet game client then synchronizes the decoded video and audio data according to a time stamp attached in the transmission package, and outputs the decoded audio and video data in the Internet game.

One embodiment of the invention is directed to a storage medium for storing a computer program, wherein the computer program, applied in a computer system, executes the method of real-time video-audio interaction in an Internet game for application to an Internet game client. The method may include the steps mentioned above.

Another embodiment is directed to a computer system of an Internet game, executing an Internet game and having a storage medium for storing a computer program, wherein the computer program is applied in a computer system and executes the method of real-time video-audio interaction in an Internet game for application to an Internet game client. The method may include the steps mentioned above.

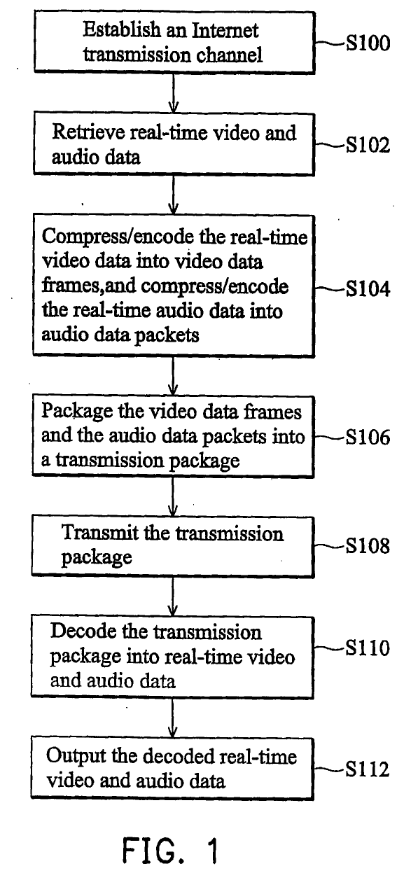

FIG. 1 is a flowchart of the method of real-time video-audio interaction in an Internet game. First, the method establishes an Internet transmission channel without first connecting to an Internet game server (step S100). The Internet transmission channel can be established by any standard Internet transmission protocol, such as TCP/IP. The establishment of the Internet transmission channel is accomplished by certain steps. One Internet game client, i.e. sender Internet game client, designates an Internet address of another Internet game client, i.e. recipient Internet game client, directly or according to a directory which may include all Internet addresses of possible recipient Internet game clients. The sender Internet game client then transmits a connection request to the recipient Internet game client. The recipient Internet game client establishes the Internet transmission channel according to the connection request. In the meantime, the Internet game clients connect to the Internet game server to execute the Internet game.

Next, real-time video and audio data are retrieved in the sender Internet game client (step S102). The real-time video data may be retrieved by a video capture device, such as camera. The real-time audio data may be retrieved by an audio capture device, such as microphone.

The sender Internet game client then compresses/encodes the real-time video data into video data frames, and compresses/encodes the real-time audio data into audio data packets (step S104). The compression can apply standard data compression formats, such as H.263, MPEG 1/2/4, and G723.

Afterwards, the video and audio data packets are packaged into a transmission package (step S106). Because the smoothness of audio data and the synchronization between video and audio data are the most important concerns of the Internet real-time video-audio data transmission, the inventive method considers the audio data as the highest transmission priority in the transmission package, such that, if the bandwidth of the Internet transmission channel cannot support the real-time video and audio data transmission simultaneously, the audio data takes a higher transmission priority than the video data. In addition, a time stamp will be attached in the transmission package for synchronizing the video and audio data. Thus, the inventive method guarantees the smoothness of audio data and the synchronization of video and audio data.

Continuing, the transmission package is transmitted to the recipient Internet game client through the Internet transmission channel (step S108). Finally, the recipient Internet game client decodes the transmission package into real-time video and audio data (step S110), synchronizes the real-time video and audio data according to the time stamp, outputs the decoded real-time video data in game environments of the Internet game, and outputs the decoded real-time audio data (step S112). The real-time interactive video data is integrated into game environments of the Internet game as texture mapping, implementing the simultaneous display of game environments and the real-time video data.

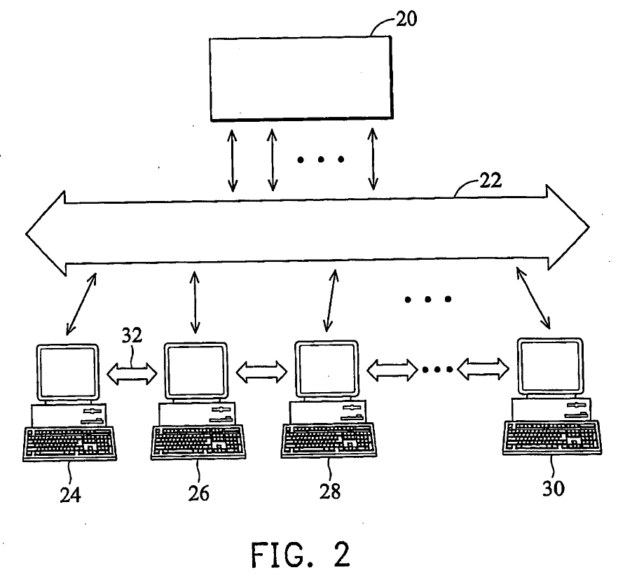

FIG. 2 is a diagram of the system of real-time video-audio interaction in an Internet game of the invention. In one embodiment, the inventive system includes an Internet game server 20 and Internet game clients 24, 26, 28, 30. The Internet game server 20 executes an Internet game main program. The Internet game clients 24, 26, 28, 30, include interactive Internet game clients 24, 26, and an Internet transmission channel 32. The Internet game clients 24, 26, 28, 30, connect to the Internet game server 20 to construct an Internet game network 22. The Internet transmission channel 32 connects to the interactive Internet game clients 24, 26 without connecting to the Internet game server 20.

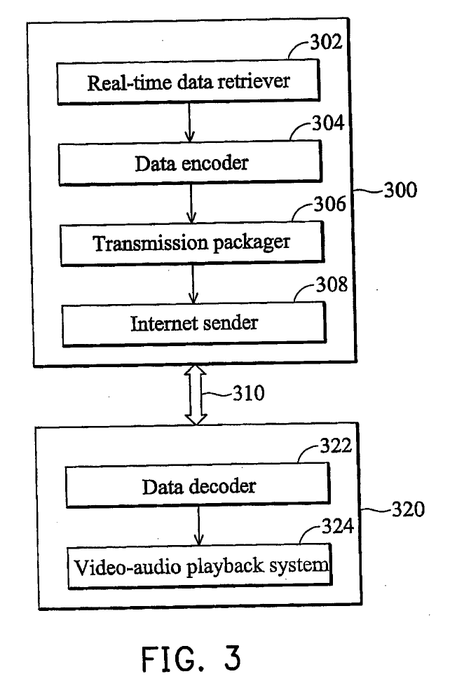

FIG. 3 is a detailed diagram of the system of real-time video-audio interaction in an Internet game. The sender Internet game client 300 has a real-time data retriever 302, a data encoder 304, a transmission packager 306, and an Internet sender 308. The real-time data retriever 302 retrieves real-time video and audio data from the Internet game client 300. The real-time data retriever 302 may comprise separate devices retrieving and processing video and audio data separately or an integrated device. The real-time data retriever 302 can be any data capture device, such as camera or microphone.

The data encoder 304 compresses/encodes the real-time video data into video data frames, and the real-time audio data into audio data packets. The data encoder 304 may comprise separate devices to compress/encode video and audio data separately or an integrated device.

The transmission packager 306 assigns the audio frames highest transmission priority and packages the video frames and audio data packets into a transmission package. The Internet sender 308 transmits the transmission package to the recipient Internet game client 320 through the Internet transmission channel 310. As an example, the transmission packager 306, the Internet sender 308, and the Internet transmission channel 310 can be implemented by programming into computer-executive modules in program languages to achieve the operations described.

The recipient Internet game client 320 includes a data decoder 322 and a video-audio playback system 324. The data decoder 322 decodes the transmission package into real-time video and audio data. Here, the data decoder 322 can comprise separate devices or designed an integrated device. The data encoder 304 and the data decoder 322 may be implemented by programming into computer-executive modules in program languages to achieve the mentioned functions.

The video-audio playback system 324 synchronizes the decoded video and audio data according to the time stamp attached. The video-audio playback system 324 integrates the decoded real-time video data into game environment of the Internet game as texture mapping. The video-audio playback system 324 outputs the real-time audio data by a sound card with audio input or output. The real-time video-audio interaction between the Internet game clients is bi-directional, that is, the Internet game clients for real-time video-audio interaction are provided with both sender and recipient functions. All components and functions of both sender and recipient are provided in the sender Internet game client 300 and the recipient Internet game client 320.

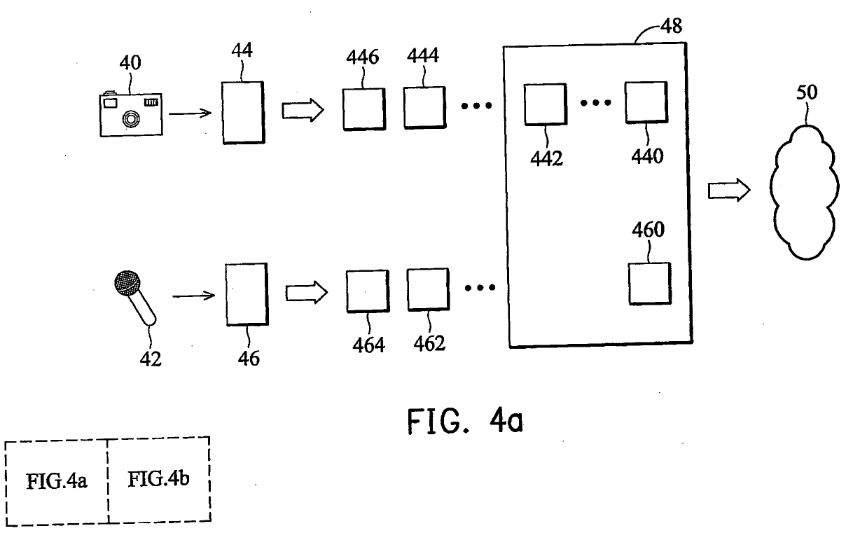

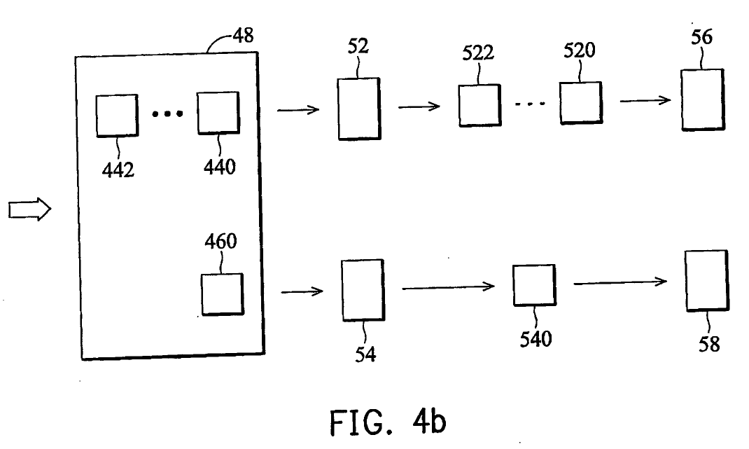

FIG. 4a, FIG. 4b are diagrams of the method of real-time video-audio interaction in an Internet game. An Internet transmission channel 50 is established for transmission. The camera 40 retrieves real-time video data and microphone 42 retrieves real-time audio data.

The data encoder 44, 46, compresses/encodes the real-time video data into video data frames, 440, 442, 444, 446, P frames. The data encoder 44, 46, also compresses/encodes the real-time audio data into audio data packets 460, 462, 464, L packets. The audio data packet takes higher priority than the video data frames. The video data frames and audio data packets are packaged into a transmission package 48. In other words, the audio data frame 460 is packaged first into the transmission package in one fixed time period and the video data frames 440, 442 are then packaged according to remaining bandwidth. If only N video data frames are packaged into the transmission package, then (P-N) video data frames are not.

Through the Internet transmission channel 50, such as Internet, the Internet sender transmits the transmission package 48 to the recipient Internet game client. The data decoders 52, 54, decode the transmission package 48 into real-time video data 520 to 522 and real-time audio data 540. The Internet transmission may drop some video frames, only M video frames are received (M<=N). Obviously, the number of the video data frames 440 to 442 is equal to or larger than the number of the video data frames 520 to 522. The video decompression method, such as IPB mode, may also cause video data frame drop such that only K video data frames are decompressed. Audio frames 540 are decompressed completely. Thus, the audio first package mechanism can implement the smoothness of audio data and synchronization of the video and audio data.

The video-audio playback systems 56, 58, display the decoded video data by simultaneous support of real-time video and 3D animation, outputting real-time video data by integration into game environments as texture mapping. The video-audio playback systems 56, 58, output audio data via a sound card with audio input or output 58, achieving real-time video-audio interaction.

The methods and systems provided by the present invention can be independent from an Internet game system by establishing an Internet transmission channel between Internet game clients, accomplishing real-time video-audio interaction in an Internet game. The invention enhances the reality of the Internet game without further burdening the Internet game server, resolving problems of the existing technology.

It will be appreciated from the foregoing description that the system and method described herein provide a dynamic and robust solution to real-time video-audio interaction problems. If, for example, an Internet game client changes data capture devices, the system and method of the present invention can be revised accordingly.

The methods and system of the present invention, or certain aspects or portions thereof, may take the form of program code (i.e., instructions) embodied in tangible media, such as floppy diskettes, CD-ROMS, hard drives, or any other machine-readable storage medium, wherein, when the program code is loaded into and executed by a machine, such as a computer, the machine becomes an apparatus for practicing the invention. The methods and apparatus of the present invention may also be embodied in the form of program code transmitted over some transmission medium, such as electrical wiring or cabling, through fiber optics, or via any other form of transmission, wherein, when the program code is received and loaded into and executed by a machine, such as a computer, the machine becomes an apparatus for practicing the invention. When implemented on a general-purpose processor, the program code combines with the processor to provide a unique apparatus that operates analogously to specific logic circuits.

While the invention has been described by way of example and in terms of the preferred embodiments, it is to be understood that the invention is not limited to the disclosed embodiments. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method of real-time video-audio interaction in an Internet game, comprising the steps of:
executing an Internet game in a first Internet game client and a second Internet game client and connecting the first and second Internet game clients to an Internet game server;
locating an established Internet transmission channel between the first Internet game client and the second Internet game client, wherein the transmission channel is not connected to the Internet game server;
retrieving first real-time video data and first real-time audio data from the first Internet game client;
compressing/encoding the first real-time video data into a plurality of first video data frames, and compressing/encoding the first real-time audio data into a plurality of first audio data packets;
packaging the first video data frames and the first audio data packets into a transmission package in the first Internet game client;
transmitting the transmission package to the second Internet game client through the Internet transmission channel;
decoding the transmission package into second real-time video data and second real-time audio data in the second Internet game client; and
outputting the second real-time audio data and the second real-time video data in the Internet game in the second Internet game client.

2. The method as claimed in claim 1, wherein the establishment of the Internet transmission channel further comprises the steps of:
designating an Internet address of the second Internet game client directly or according to a directory by the first Internet game client, wherein the directory includes the Internet address of the second Internet game client;
transmitting a connection request from the first Internet game client to the second Internet game client; and
establishing the Internet transmission channel by the second Internet game client according to the connection request.

3. The method as claimed in claim 1, wherein if the bandwidth of the Internet transmission channel cannot transmit the first real-time audio data and the first real-time video data simultaneously, the first real-time audio data takes a higher transmission priority than the first real-time video data.

4. The method as claimed in claim 1, wherein playback of the second real-time video data is accomplished by integrating the second real-time video data into the game environments of the Internet game as texture mapping.

5. The method as claimed in claim 1, wherein the transmission package further comprises a time stamp, defining the synchronized relationship between the first real-time audio data and the first real-time video data.

6. The method as claimed in claim 5, wherein playback of the second real-time audio data and the second real-time video data is synchronized according to the time stamp synchronizing the second real-time audio data and the second real-time video data.

7. A system of real-time video-audio interaction in an Internet game, comprising:
an Internet game server, executing an Internet game; and
a plurality of Internet game clients, comprising a first Internet game client, a second Internet game client, and an Internet transmission channel, the first and the second Internet game clients connecting to the Internet game server, the Internet transmission channel coupled to the first Internet game client and the second Internet game client.

8. The system as claimed in claim 7, wherein the first Internet game client further comprises:
a real-time data retriever, retrieving first real-time video data and first real-time audio data from the first Internet game client;
a data encoder, coupled to the real-time data retriever, compressing/encoding the first real-time video data into a plurality of first video data frames, and compressing/encoding the first audio data into a plurality of first audio data packets;
a transmission packager, coupled to the data encoder, packaging the first video data frames and the first audio data packets into a transmission package; and
an Internet sender, coupled to the transmission packager, transmitting the transmission package to the second Internet game client through the Internet transmission channel.

9. The system as claimed in claim 8, wherein if the bandwidth of the Internet transmission channel cannot transmit the first real-time audio data and the first real-time video data simultaneously, the first real-time audio data takes a higher transmission priority than the first real-time video data.

10. The system as claimed in claim 8, wherein the transmission package further comprises a time stamp, defining the synchronized relationship between the first real-time audio data and the first real-time video data.

11. The system as claimed in claim 7, wherein the second Internet game client further comprises:
a data decoder, coupled to the Internet transmission channel, decoding the transmission package into second video data and second audio data;
a video-audio playback system, coupled to the data decoder, outputting the second video data and the second audio data.

12. The system as claimed in claim 11, wherein the video-audio playback system mixes the second real-time video data into game environments of the Internet game as texture mapping.

13. The system as claimed in claim 11, wherein the video-audio playback system synchronizes the second real-time audio data and the second real-time video data according to the time stamp.

14. The system as claimed in claim 7, wherein the Internet transmission channel is established by designating an Internet address of the second Internet game client directly or according to a directory by the first Internet game client, transmitting a connection request from the first Internet game client to the second Internet game client, and the second Internet game client establishing the Internet transmission channel according to the connection request, wherein the directory includes the Internet address of the second Internet game client.

15. A method of real-time video-audio interaction in an Internet game for application to an Internet game client, wherein the Internet game client connects to an Internet game server, and executes an Internet game, comprising the steps of:
locating an established Internet transmission channel to a external Internet game client, wherein the Internet transmission channel is not connected to the Internet game server;
a real-time data retriever retrieving first real-time video data and first real-time audio data;
compressing/decoding the first real-time video data and the first real-time audio data into a first transmission package;
transmitting the first transmission package to the external Internet game client through the Internet transmission channel;
receiving a second transmission package from the external Internet game client through the Internet transmission channel;
decompressing/decoding the second transmission package into second real-time video data and second real-time audio data; and
outputting the second audio data and the second video data in the game environment.

16. The method as claimed in claim 15, wherein the establishment of the Internet transmission channel further comprises the steps of:
designating an Internet address of a third external Internet game client by the Internet game client or the external Internet game client;
transmitting a connection request to the third Internet game client by the Internet game client or the external Internet game client according to the Internet address; and
establishing the Internet transmission channel between the Internet game client and the third Internet game client.

17. The method as claimed in claim 15, wherein if the bandwidth of the Internet transmission channel cannot transmit the first real-time audio data and the first real-time video data simultaneously, the first real-time audio data takes a higher transmission priority than the first real-time video data.

18. The method as claimed in claim 15, wherein in the searching step, the Internet transmission channel is established according to a directory having an Internet address of the third external Internet game client.

19. The method as claimed in claim 15, wherein playback of the second video data is accomplished by integrating the second real-time video data into the game environment as texture mapping.

20. The method as claimed in claim 15, wherein the first transmission package further comprises a time stamp, defining the synchronized relationship between the first real-time audio data and the first real-time video data.

21. The method as claimed in claim 15, wherein the second transmission package further comprises a time stamp, defining the synchronized relationship between the second real-time audio data and the second real-time video data for output.

22. A storage medium for storing a computer program, wherein the computer program, applied in a computer system, executes the method of real-time video-audio interaction in an Internet game for application to an Internet game client, the Internet game client connecting to an Internet game server, executing an Internet game, and outputting a game environment, the method comprising the steps of:
locating an established Internet transmission channel to a external Internet game client, wherein the Internet transmission channel is not connected to the Internet game server;
retrieval of first real-time video data and first real-time audio data by a real-time data retriever;
compressing/decoding the first real-time video data and the first real-time audio data into a first transmission package;
transmitting the first transmission package to the external Internet game client through the Internet transmission channel;
receiving a second transmission package from the external Internet game client through the Internet transmission channel;
decompressing/decoding the second transmission package into second real-time video data and second real-time audio data; and
outputting the second audio data and the second video data in the game environment in the monitor.

23. The storage medium as claimed in claim 22, wherein the searching step further comprises the steps of:
designation of an Internet address of a third external Internet game client by the Internet game client or the external Internet game client;
transmission of a connection request to the third Internet game client by the Internet game client or the external Internet game client according to the Internet address; and
establishing the Internet transmission channel between the Internet game client and the third Internet game client.

24. The storage medium as claimed in claim 22, wherein if the bandwidth of the Internet transmission channel cannot transmit the first real-time audio data and the first real-time video data simultaneously, the first real-time audio data takes a higher transmission priority than the first real-time video data.

25. The storage medium as claimed in claim 22, wherein the Internet transmission channel is established according to a directory, having an Internet address of the external Internet game client.

26. The storage medium as claimed in claim 22, wherein playback of the second video data is accomplished by integrating the second real-time video data into the game environment as texture mapping.

27. The storage medium as claimed in claim 22, wherein the first transmission package further comprises a time stamp, defining the synchronized relationship between the first real-time audio data and the first real-time video data.

28. The storage medium as claimed in claim 22, wherein the second transmission package further comprises a time stamp, defining the synchronized relationship between the second real-time audio data and the second real-time video data for output.

29. A computer system of an Internet game, executing an Internet game and having a storage medium for storing a computer program, wherein the computer program is applied in a computer system and executes the method of real-time video-audio interaction in an Internet game for application to an Internet game client, the Internet game client connecting to an Internet game server, executing an Internet game, and outputting a game environment, the method comprising the steps of:
locating an established Internet transmission channel to a external Internet game client, wherein the Internet transmission channel is not connected to the Internet game server;
retrieval of first real-time video data and first real-time audio data by a real-time data retriever;
compressing/decoding the first real-time video data and the first real-time audio data into a first transmission package;
transmitting the first transmission package to the external Internet game client through the Internet transmission channel;
receiving a second transmission package from the external Internet game client through the Internet transmission channel;
decompressing/decoding the second transmission package into second real-time video data and second real-time audio data; and
outputting the second audio data and the second video data in the game environment in the monitor.

30. The computer system as claimed in claim 29, wherein the establishment of the Internet transmission channel further comprises the steps of:
designation of an Internet address of a third external Internet game client by the Internet game client or the external Internet game client;
transmission of a connection request to the third Internet game client by the Internet game client or the external Internet game client according to the Internet address; and
establishing the Internet transmission channel between the Internet game client and the third Internet game client.

31. The computer system as claimed in claim 29, wherein if the bandwidth of the Internet transmission channel cannot transmit the first real-time audio data and the first real-time video data simultaneously, the first real-time audio data takes a higher transmission priority than the first real-time video data.

32. The computer system as claimed in claim 29, wherein in the searching step, the Internet transmission channel is established according to a directory, having an Internet address of the third external Internet game client.

33. The computer system as claimed in claim 29, wherein playback of the second video data is accomplished by integrating the second real-time video data into the game environment as texture mapping.

34. The computer system as claimed in claim 29, wherein the first transmission package further comprises a time stamp, defining the synchronized relationship between the first real-time audio data and the first real-time video data.

35. The computer system as claimed in claim 29, wherein the second transmission package further comprises a time stamp, defining the synchronized relationship between the second real-time audio data and the second real-time video data for output

36. A method of real-time video-audio interaction in an Internet game for application to a first Internet game client and a second Internet game client, wherein the first and second Internet game client execute an Internet game and connect to an Internet game server, comprising the steps of:
establishing an Internet transmission channel between the first Internet game client and the second Internet game client, wherein the Internet transmission channel is not connected to the Internet game server;
retrieving first real-time video data and first real-time audio data from the first Internet game client;
producing a plurality of first video data frames and a plurality of first audio data packets;
packaging the first video data frames and the first audio data packets into a transmission package;
transmitting the transmission package to the second Internet game client;
decoding the transmission package into second real-time video data and second real-time audio data in the second Internet game client; and
outputting the second real-time audio data and the second real-time video data in the Internet game in the second Internet game client.

37. The method as claimed in claim 36, wherein the establishing step further comprises the steps of:
designating an Internet address of the second Internet game client directly or according to a directory by the first Internet game client, wherein the directory includes the Internet address of the second Internet game client;
transmitting a connection request from the first Internet game client to the second Internet game client; and
establishing the Internet transmission channel by the second Internet game client according to the connection request.

38. The method as claimed in claim 36, wherein the first real-time audio data is primarily packaged into the first transmission package, and the remaining bandwidth is used for packaging the first real-time video data.

39. The method as claimed in claim 36, wherein the first video data frames and the first audio data packets are produced by compressing/encoding.

40. The method as claimed in claim 36, wherein the transmission package is transmitted to the second Internet game client through the Internet transmission channel.

41. A system of real-time video-audio interaction in an Internet game for application to a first Internet game client, a second Internet game client, and an Internet game server, wherein the Internet game server executes an Internet game, the system comprising:
an Internet transmission channel, the first Internet game client and the second Internet game client connecting to the Internet game server to execute the Internet game, the Internet transmission channel coupled to the first and second Internet game clients to execute real-time video-audio interaction.
